(19) United States
(12) Patent Application Publication
(10) Pub. No.: US 2005/0021867 A1
(43) Pub. Date: Jan. 27, 2005

(54) Synchronization arrangement

(75) Inventors: Tiina Partanen, Tampere (FI); Ari Lehtola, Pirkkala (FI); Sami Pajusaari, Kangasala (FI); Samuli Ylinen, Tampere (FI); Jouni Rapakko, Kylmakoski (FI); Mikko Sahinoja, Tampere (FI); Jani Vuorinen, Helsinki (FI)

Correspondence Address: Crawford Maunu PLLC, Suite 390, 1270 Northland Drive, St. Paul, MN, 55120, US

(73) Assignee: Nokia Corporation

(21) Appl. No.: 10/855,134

(22) Filed: May 27, 2004

(30) Foreign Application Priority Data
Jun. 10, 2003 (FI) 20030864

(51) Int. Cl. G06F 15/16

(52) U.S. Cl. 709/248

(57) ABSTRACT

The invention relates to arranging synchronization of data in an information system comprising at least two separate datasets to be synchronized and a data storage into which data in the datasets to be synchronized is stored and from which the data to be synchronized is delivered to the datasets. The solution comprises determining at least some of the fields of at least one data type as search settings. From a record stored or to be stored in the data storage, at least one character string is determined as a search key on the basis of at least one predetermined search setting, and the search key associated with the record is stored. In response to receiving a search expression corresponding to the search key, the data storage is searched for the data associated with the search key.

### FIELD OF THE INVENTION

The invention relates to a synchronization arrangement for synchronizing data, and particularly to utilizing a centralized data storage in a synchronization arrangement.

### BACKGROUND OF THE INVENTION

As the use of portable terminal devices in particular, such as portable computers and PDA (Personal Digital Assistant) devices, increases and becomes more versatile, the data in such terminal devices may be synchronized with network applications, desktop computer applications or other databases of a telecommunication system. Typically, a synchronization protocol is used between two devices, such as a personal computer (PC) and a mobile station, when synchronizing e.g. the data of PIM (Personal Information Manager) applications over a local connection. In such a case, the data in the mobile station is modified to a form determined by this protocol and, correspondingly, it is modified to a form understood by an application of the PC when data is transferred from the mobile station to the computer. A corresponding procedure also applies to the reverse direction. This approach, however, faces the problem that if the PC has several applications using the same data, synchronization has to be carried out several times as well. This is because typically, applications on a PC are incapable of exchanging information. It is also possible that some applications do not support the synchronization protocol used between a PC and a mobile station at all.

U.S. Pat. No. 6,295,541 discloses a method for avoiding this problem. The method comprises forming a reference dataset to which different devices transmit their data to be synchronized, e.g. a new data unit added to a device. When a device adds a new entry to such a reference dataset, a centralized synchronization system maintaining the reference dataset may also synchronize the entry to the rest of the devices in the synchronizing system. In such a case, not all devices need to be capable of synchronizing with each other but a synchronization function centralized in one computer is responsible for synchronizing the data to the applications residing in different devices. The problem with the implementation of U.S. Pat. No. 6,295,541 is, however, that it is not possible for external applications (applications external to the centralized synchronization system, e.g. a client application residing in a different device) to search through the reference dataset for data, e.g. contact information associated with a particular name.

### BRIEF DESCRIPTION OF THE INVENTION

An object of the invention is thus to provide a method and an apparatus implementing the method so as to enable the above-mentioned problem to be avoided. The object of the invention is achieved by a method, a synchronization system, a data processing device and a computer software product which are characterized by what has been disclosed in the independent claims. Preferred embodiments of the invention are disclosed in the dependent claims.

In accordance with the invention, at least some of the fields of at least one data type are determined as search settings. From a record stored or to be stored in a data storage, at least one character string is determined as a search key on the basis of at least one predetermined search setting, and the search key associated with the record is stored. In response to receiving a search expression corresponding to the search key, the data storage is searched for the data associated with the search key.

Synchronization generally refers to data transfer between at least two different datasets; after synchronization, the datasets may correspond to each other or only some of the data is transferred or synchronization is carried out in one direction only, in which case the datasets do not necessarily correspond to each other after synchronization.

An advantage of the arrangement of the invention is that records stored in a centralized data storage of the synchronization arrangement can also be searched for. Since several different applications or, possibly, devices may be provided with access to the centralized data storage in order to enable synchronization, the applications or devices may easily conduct searches across the data storage. This enables a sought record to be quickly found in the centralized data storage. Only some of the fields of the records can be predetermined in search settings; therefore, a list of search keys is compact, making the search keys quicker to be determined and traversed during a search, as compared with a situation wherein all fields served as search keys. Preferably, the records are stored using a standard format supported by the applications utilizing a data storage, which enables the same search settings to be used for all records to be synchronized, with no need for the laborious conversion from one application or device specific format to another. Since, according to a preferred embodiment of the invention, a search can be carried out across a data structure only comprising search keys and reference to the actual record (possibly residing in a different data storage), the actual record may be stored in a manner most suitable therefor. In such a case, the search keys may also be stored in a data structure optimized for search operations.

According to a preferred embodiment of the invention, at least one of the datasets from which data is transferred to a data storage resides in a mobile station, and in such an information system, an interface is arranged for at least one application utilizing the data storage for transferring data to and from the mobile station such that the data is stored in the data storage before being transferred to the mobile station and before being transferred to the applications. The synchronization arrangement thus enables an interface to be provided for the data in the mobile station and the mobile station to be searched for the data therein in a centralized manner on the basis of the data stored in the data storage.

### BRIEF DESCRIPTION OF THE DRAWINGS

The invention is now described in closer detail in connection with the preferred embodiments and with reference to the accompanying drawings, in which

FIG. 1 generally illustrates a synchronization system wherein data in different datasets can be synchronized through a centralized data storage;

FIG. 2 shows a synchronization architecture according to a preferred embodiment of the invention;

FIG. 3 illustrates a synchronization method according to a preferred embodiment of the invention; and

FIG. 4 illustrates a synchronization architecture according to a preferred embodiment of the invention.

### DETAILED DESCRIPTION OF THE INVENTION

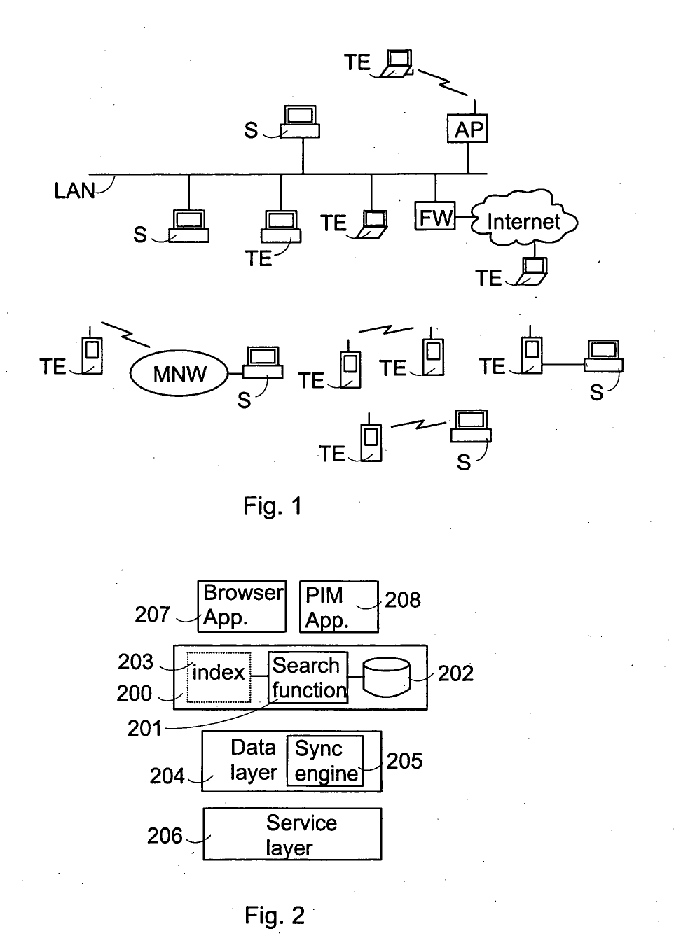

FIG. 1 illustrates a networked system wherein data residing in databases can be synchronized between servers S and terminal devices TE, between terminal devices TE or between servers S. A database subjected to synchronization is to be understood in a broad sense to refer to any memory means. If synchronization takes place between terminal devices TE or servers S, one of the terminal devices TE or servers S, as far as synchronization is concerned, operates as a synchronization server, e.g. as a SyncML synchronization server specified in a SyncML standard while the rest of the terminal devices TE or servers S participating in a synchronization session operate as a synchronization client (SyncML client). A server S may serve several client devices TE. Typically, a network server or a PC operates as a server S. Typically, TE consists of a mobile station, a PC (Personal Computer), a laptop computer or a PDA device. In the first example of FIG. 1, client devices TE and synchronization servers S are connected to a local area network LAN. A client device TE connected to the network LAN comprises a functionality, e.g. a network card and software controlling data transfer, for communicating with the devices in the network LAN. The terminal device TE may be connected to a server S also over the Internet, typically using a firewall FW. The terminal device TE may be connected to the local area network LAN also wirelessly via an access point AP.

In the second example, the client device TE is a mobile station communicating with a server S through a mobile network MNW. The terminal device TE connected to the network MNW comprises a mobile station functionality for arranging wireless data transfer with the network MNW. Other networks, such as a local area network LAN, may also be provided between the mobile network MNW and the server S. The mobile network MNW may be any already known wireless network, e.g. a network supporting a GSM service, a network supporting a GPRS (General Packet Radio Service) service, a third generation mobile network, such as a wireless local area network WLAN according to the network specifications of a 3GPP (3^{rd} Generation Partnership Project), or a private network. Many other synchronization configurations, such as synchronization between terminal devices TE or synchronization between a terminal device TE and a server, are also possible using a wired or a wireless connection. Synchronization may also take place internally between at least two datasets of a device.

The terminal device TE and the server S comprise memory, a user interface, I/O mans for arranging data transfer, and a central processing unit comprising one or more processors. According to a preferred embodiment, TE operating as a client device according to the SyncML standard comprises a client agent CA, which is responsible for functions associated with a synchronization session in the client device. The SyncML synchronization server functionality in the server S consists of a synchronization server agent SA (Sync Server Agent) and a synchronization block SE (Sync Engine). The client agent CA may be implemented by executing in a central processing unit of the client device a computer program code stored in memory, and the sync server agent SA and the sync engine SE by executing in the central processing unit of the server a computer program code stored in the memory of the server. The TE and the S may operate as a synchronization server and/or as a client device. Consequently, e.g. the terminal device TE may at least partly also comprise the functions of the sync server agent SA, in which case it may operate as a synchronization server in the synchronization between terminal devices TE. The computer program codes to be executed in the central processing units enable the terminal device TE and/or the server S to also implement the inventive means relating to the centralized storing of and searching for the data to be synchronized, some embodiments thereof being illustrated in FIGS. 2, 3 and 4. The computer program may be stored in any memory means, e.g. on a hard disk of a PC or on a CD-ROM disc, from which it may be downloaded into the memory of the device TE, S executing it. The computer program may also be downloaded through a network, using e.g. a TCP/IP protocol stack. It is also possible to use hardware solutions or a combination of hardware and software solutions to implement the inventive means.

FIG. 2 illustrates a synchronization architecture according to a preferred embodiment, which may be implemented e.g. in a server S. The synchronization architecture comprises means 200 for maintaining and using a centralized data storage 202 on the basis of synchronization between different devices and applications. Data to be synchronized, obtained from datasets subjected to synchronization, can be stored in the centralized data storage 202, and data to be synchronized can be delivered to datasets therefrom. The data storage 202 may be any information structure, such as any database, linked list, table or tree information structure. Preferably, at least a search function 201, applications contained in the server S, such as a browser application 207 and a PIM application 208, and a synchronization module 205 of a data layer 204, e.g. a sync engine SE according to the SyncML protocol, have access to the data storage 202. According to an embodiment, the browser application 207 may provide a user of the server S with a view of the files of the user's terminal device TE and the records stored therein on the basis of the data synchronized from the terminal device TE to the data storage 202. Generally, the PIM application 208 is any application which enables the user to modify the information stored in the server S and/or the terminal device TE, in which case e.g. modifications to contact information carried out on the server S can be synchronized to the terminal device TE, or vice versa. Typically, the PIM application has datasets of its own, and data can be transferred between a dataset of the PIM application and the data storage 202. The data to be synchronized and transferred between datasets residing in different applications and/or devices and the data storage 202 may comprise data records subjected to synchronization or information on changes made to the data records. The architecture may also comprise other applications utilizing the centralized data storage 202, e.g. a message editor or a message transmission application.

According to a preferred embodiment, at least one of the datasets from which data is transferred to the data storage 202 resides in a wireless terminal device TE, and the information system comprises an interface arranged for different applications for transferring data to and from the wireless terminal device such that the data is stored in the data storage before being transferred to the wireless terminal device and before being transferred to the applications. Consequently, datasets whose data is stored in the data storage 202 may reside outside the server S and in the memory of the server S in the storage areas used e.g. by applications 205, 207, 208. The applications 205, 207, 208 in the same device and applications in other devices, such as the terminal device TE to be synchronized, may thus constitute the clients of the data storage 202. The data storages 202 may be e.g. terminal device specific or user specific.

An advantage of the synchronization architecture comprising a centralized data storage shown in FIG. 2 is that the data synchronized to the data storage 202 e.g. from the terminal device TE can be efficiently distributed or synchronized 207, 208 to several applications through one interface such that not every single application 207, 208 has to synchronize with the terminal device TE separately. This enables problems caused by separate synchronizations to be avoided. The means 200 may also provide external applications 205, 207, 208 with an interface for modifying the records contained in the data storage 202. This can be arranged e.g. by using data type specific modules that comprise the necessary modification and conversion functions.

A service layer 206 may be used for arranging data transport services from the server S, such as transport services provided by an OBEX protocol. External data transfer connections can be arranged from the server S to the terminal device TE and to other devices by using e.g. any one of the transfer techniques mentioned in connection with FIG. 1.

According to a preferred embodiment, the system further comprises a search functionality 201, which collects information on the records to be stored in the data storage 202 to be used when searching for records and which provides the applications of the server S, such as the applications 205, 207 and 208, with a search interface. According to a preferred embodiment, the search keys and the actual record are stored in separate data storages or information structures. FIG. 1 shows an index 203 for storing search keys and a data storage 202 for storing records. Since, according to a preferred embodiment of the invention, a search may be carried out across an information structure only comprising search keys and reference to the actual record in a different data storage, the actual record can be stored in a manner most suitable therefor, e.g. as a whole in a vCard form or as a message to a file system. In such a case, the search keys may also be stored in an information structure optimized for search operations, e.g. in a linked alphabetical list or a database.

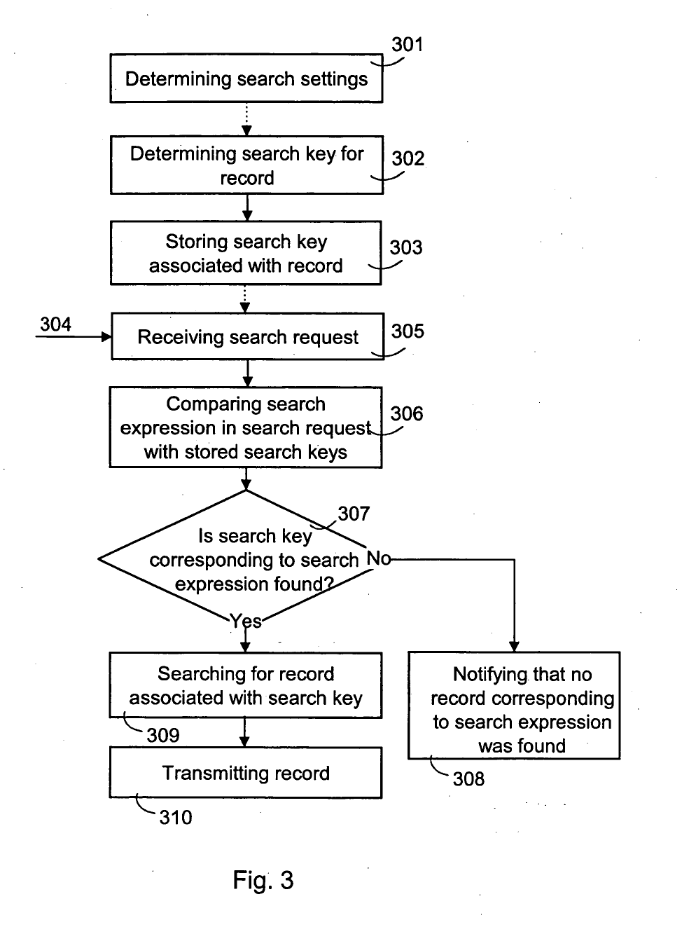

FIG. 3 illustrates a method according to a preferred embodiment for implementing a search functionality 201. The functionality illustrated in FIG. 3 may also well be applied to a terminal device TE maintaining a centralized data storage. In step 301, at least some of the fields of data types are determined as search settings. The search settings can be set data type specifically and the search functionality 201 may support all data types to be stored in the data storage 202 such that the search functionality is capable of searching through the records for the contents of the fields determined in the search settings. The fields may be determined as default settings, which can preferably be modified by the user. Step 301 may also be carried out when activating the search activity, on the basis of which the determination of search keys is started. Step 302 comprises determining a search key for a record on the basis of at least one field determined for the data type of the record in the search settings. The search key may be determined 302 already before storing the record in the data storage 202, or only after it. Typically, search keys are determined 302 for new records immediately after they, during a synchronization session, have been stored in a data storage e.g. by a synchronization module 205. The at least one search key associated with the record is stored 303, preferably in a separately maintained index 203 for search keys. Preferably, the search functionality 201 continuously monitors the records to be stored in the data storage 202, and executes steps 302 and 303.

When a search request 304 is received 305 from an application operating as a search client, such as an application 207, 208, a search expression contained in the search request is compared 306, 307 with the stored search keys. If no search key corresponding to the search expression can be found, the application is replied 308 that no record according to the search expression was found in the data storage. This notification is transmitted to the application that originated the request 304, and the application may possibly also show the information to the user through a user interface.

If a search key corresponding to the search expression was found, the data storage 202 is searched 309 through for the record corresponding to the search key and, typically, it is transmitted 310 to the application that transmitted the search request 304. Alternatively, depending on the implementation, the address of the record in the data storage 202 obtained from the index 203, or another reference to the record may be transmitted and, when necessary, the application itself may search for the record. In such a case, the file name of the record and the path to the record can be returned to the application that transmitted the search expression. This embodiment can be applied e.g. to a browser application 207 to which only one or several search keys, e.g. the transmitter of a message or transmission time, can be retrieved to be shown on the use interface.

According to an embodiment, the search keys are stored 303 in the data storage 202 as objects that have been stored in data structures optimized for a search. Such data structures include e.g. alphabetized or arranged trees. Particularly data structures optimized for searches conducted based on names are useful when processing data in a mobile station. The objects are provided with a unique identifier and they can be returned to the application that requested the search. A search function 201 may only be provided for reading data, or the data in a data storage may also be arranged to be modified through such a function.

In the following, a synchronization example according to a preferred embodiment will be shown for synchronizing a dataset maintained by a first application and a dataset maintained by a second application by using a centralized data storage 202. A first dataset resides in a terminal device TE and a second dataset in a server S, more specifically, maintained by a PIM application 208 of the server S. First, data is synchronized between the dataset of the terminal device TE and the centralized data storage 202, in which case e.g. a contact card added to the terminal device TE after the previous synchronization session is also stored in the data storage 202. The synchronization may be implemented according to a preferred embodiment by means of a synchronization module 205 supporting the SyncML protocol. For more detailed information on the SyncML synchronization protocol, reference is made to the SyncML specification “SyncML Sync Protocol, version 1.1.1”, 2 Oct. 2002, 63 pages, by OMA.

The search functionality 201 also forms search keys to an index 203 from the new contact card. The new or modified records stored in the data storage 202 may be used for forming search keys only after both synchronization sessions are completed, or after each synchronization session. The modifications made to the data storage 202 may also be transferred to other applications using the centralized synchronization system, e.g. to a browser application 207, and/or such modifications may be synchronized to the storage area used by other applications using the centralized synchronization system. The modifications can be automatically synchronized from the data storage to a dataset. For example, the contact card (originally added to a terminal device) is synchronized from the data storage 202 to the contact information on the PIM application. Typically, this synchronization is implemented using proprietary protocols, but standard protocols, such as the SyncML protocol, may naturally also be used. It is also possible that the data storage 202 is used as a cache memory to be searched for data by the applications 205, 207, 208 when necessary, utilizing the already above-described search functionality.

The search functionality 201 may be used for many different functions; some examples of such functions will be given in the following. When a user wishes to browse the contact information on his or her mobile station by a server S (which is typically a PC), a search key is transmitted from a browser application 207, on the basis of which a data storage 203 is searched for contact information, preferably by using an index 203. The data storage is searched for records corresponding to the search key, and such records are transmitted to the browser application 207 to be shown to the user. According to a more detailed example, a list is shown to the user in a message editor on the basis of name fields maintained by the search functionality, wherefrom the user is able to choose the receivers. When the user is entering a telephone number, the information associated with the telephone number being entered is searched for on the basis of telephone number fields of the index 203. A similar procedure may also take place when entering an e-mail address, i.e. the data storage 203 may be searched for the contact card associated with such an address.

An application for the functionality illustrated above is PIM synchronization wherein personal information stored in a mobile station is synchronized with information stored in a personal computer. This information may be any information fed or selected by a user, but the most frequently used information consists of contact information and calendar entries.

Preferably, the records are stored using a standard storage format supported by applications utilizing a data storage, in which case the same search settings may be used for all records to be synchronized, with no need for the laborious conversion from one application or device specific presentation format to another. Typically, standard form records may be extended by proprietary additions or by using optional fields, which enables the needs of the search function 201 and the different applications 205, 207, 208 to be taken into account appropriately. Since only some of the fields of the search keys may be used as search keys, a list of search keys can be made compact, making the search keys quicker to be determined and traversed during a search, as compared with a situation wherein all fields served as search keys. In such a case, no data type specific modules are necessary in the means 200 for modifying data stored in a data storage 202 but applications may modify the records of the data storage 202 directly.

According to a preferred embodiment of the invention, records are stored in the data storage 202 in a vCard form. Search keys may then be determined using one or more fields specified in the vCard standard. Further information on the vCard form can be found on the Internet Mail Consortium's (IMC) web pages at http://www.imc.org, where e.g. vCard v. 2.1. specification can be found.

A search key can be determined (302) from any field of a record to be stored. Typically, a large number of contact records (contact cards) and transmitted and received messages is stored and synchronized in a mobile station, in which case search keys are preferably formed from the name fields, telephone number fields and/or e-mail address fields of the records. An important piece of information related to the records is modification or storage time information, from which search keys may also formed in step 302. Search keys containing time information enable e.g. messages to be quickly arranged in an order of reception. A record may also include binary data, which is not suitable for use as a search key; e.g. a contact card record may comprise a photograph.

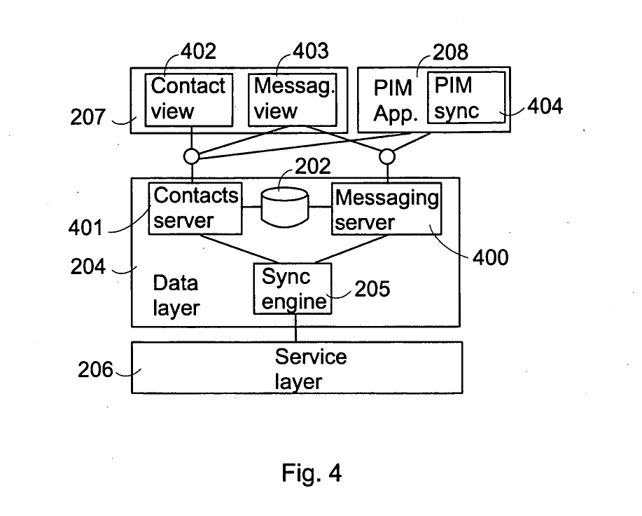

FIG. 4 illustrates a synchronization arrangement according to an embodiment. Together with a synchronization module 205, a centralized data storage 202 resides on a data layer 204. Access to the data storage 202 is arranged by two server functionalities, i.e. a messaging server 400 and a contacts server 401. The messaging server 400 is configured to be responsible for storing and processing different messages, such as short messages, MMS messages and e-mail messages, in the data storage 202 and therefrom. The contacts server 401, in turn, is configured to be responsible for storing and processing contact information, e.g. contact cards stored in the vCard form. The servers 400 and 401 are also provided with interfaces to the synchronization module 205 and they provide one or more applications 207, 208 with an interface. As distinct from FIG. 4, the data storage 202 may have separate storage areas, e.g. by files, for different servers 400, 401 to use. Alternatively, the servers 400, 401 may be provided with separate data storages 202. In the example of FIG. 4, a browser application 207 comprises a contact view 402 which enables contact information stored in the data storage 202 to be shown by means of the contacts server 401. The browser application 207 also comprises a messaging view 403 which, in turn, enables stored messages to be shown by means of the messaging server 400. The messaging view 403 enables e.g. transmitted and received MMS messages to be shown, arranged according to transmission/reception addresses. The messaging view 403 may also need the services of the contacts server 401, it may, for instance, instead of the telephone number of the transmitter or receiver of an MMS message, show a name associated with the number in the contact information. Synchronization also between the data storage 202 and an application, such as a PIM application 208, may be implemented through the server 400 and/or 401. In such a case, the server 400, 401 provides an interface for the synchronization functionality of the application 207, 208, such as a PIM synchronization functionality 404.

The search functionality 201 illustrated above may be implemented in the servers 400 and 401, in which case the contacts server 400 is responsible for the functions illustrated in connection with FIG. 3 for the contact records and, correspondingly, the messaging server 400 for the messaging records. The search functionality may be used e.g. when information on the contacts associated with an address in a message is needed in the messaging display 403. In such a case, addresses are determined and stored as search keys, and a received search expression, i.e. an address or part thereof, is compared with the already stored addresses. If an address corresponding to the search expression is found among the search keys, the information, the name in particular, may be delivered to the messaging display 403 to be shown instead of the address. Alternatively, as distinct from FIG. 4, the search functionality 201 may be centralized and differentiated from the servers 400 and 401, providing them with search interfaces. The implementation illustrated in FIG. 4 may be further modified e.g. such that each data type is provided with a server of its own to be responsible for the records of a particular data type in the data storage 202. According to an embodiment, separate search indices or object lists are formed for different applications and/or devices. A user may have e.g. several mobile stations whose contact information may be synchronized to a server S, enabling separate contact bases to be determined therefrom to be associated with the identifier of each mobile station. The user can then quickly and easily browse through the information on different mobile stations by using the search function and, for example, synchronize the contact information on a mobile station by utilizing the centralized data storage 202.

It is obvious to one skilled in the art that as technology advances, the basic idea of the invention can be implemented in many different ways. The invention and its embodiments are thus not restricted to the above-described examples but may vary within the scope of the claims.

1. A method for arranging synchronization of data in an information system comprising at least two separate datasets to be synchronized and a data storage into which data in the datasets to be synchronized is stored and from which the data to be synchronized is delivered to the datasets, the method comprising:
determining at least some of the fields of at least one data type as search settings,
determining, from a record stored or to be stored in the data storage, at least one character string as a search key on the basis of at least one predetermined search setting,
storing the search key associated with the record, and
searching for the data associated with the search key in response to receiving a search expression corresponding to the search key.

2. A method as claimed in claim 1, wherein an index is maintained in the information system for storing the search keys and for carrying out searches.

3. A method as claimed in claim 1, the method comprising:
synchronizing the contents of a first dataset and data storage,
synchronizing the contents of a second dataset and data storage,
synchronizing modifications made to the data storage in connections with synchronizing the second dataset to the first dataset, and
determining search keys from new or modified records stored in the data storage.

4. A method as claimed in claim 1, the method comprising:
returning a file name of the record associated with the search key and a path thereto to an application which transmitted the search expression.

5. A method as claimed in claim 1, wherein the search key is determined from one or more of the following pieces of information contained in a record: name, telephone number, e-mail address.

6. A method as claimed in claim 1, wherein at least one of the datasets from which data is transferred to the data storage resides in a mobile station, and in the information system, an interface is arranged for at least one application utilizing the data storage for transferring data to and from the mobile station such that the data is stored in the data storage before being transferred to the mobile station and before being transferred to the applications.

7. A synchronization system comprising at least two separate datasets to be synchronized and a data storage into which data in the datasets to be synchronized is storable and from which the data to be synchronized is deliverable to the datasets, wherein the synchronization system is configured to determine at least some of the fields of at least one data type as search settings,
the synchronization system is configured to determine, from a record stored or to be stored in the data storage, at least one character string as a search key on the basis of at least one predetermined search setting,
the synchronization system is configured to store the search key associated with the record, and
the synchronization system is configured to search for the data associated with the search key in response to receiving a search expression corresponding to the search key.

8. A data processing device comprising a data storage into which data in at least two different datasets to be synchronized is storable and from which the data to be synchronized is deliverable to the datasets, wherein the data processing device is configured to determine at least some of the fields of at least one data type as search settings,
the data processing device is configured to determine, from a record stored or to be stored in the data storage, at least one character string as a search key on the basis of at least one predetermined search setting,
the data processing device is configured to store the search key associated with a record to be synchronized, and
the data processing device is configured to search for the data associated with the search key in response to receiving a search expression corresponding to the search key.

9. A data processing device as claimed in claim 8, wherein the data processing device is configured to synchronize data to at least one dataset of a mobile station, and
the data processing device comprises an interface for at least one application utilizing the data storage for transferring data to and from the mobile station such that the data is storable in the data storage before transferral to the mobile station and before transferral to the applications.

10. A computer program product for controlling a data processing device in response to executing the computer program product in a processor of the data processing device, the computer program product comprising:
a program code portion for controlling the data processing device to determine at least some of the fields of at least one data type as search settings,
a program code portion for controlling the data processing device to determine, from a record stored or to be stored in the data storage, at least one character string as a search key on the basis of at least one predetermined search setting,
a program code portion for controlling the data processing device to store the search key associated with the record, and
a program code portion for controlling the data processing device to search for the data associated with the search key in response to receiving a search expression corresponding to the search key.
